(19) United States
(12) Patent Application Publication
(10) Pub. No.: US 2008/0230204 A1
(43) Pub. Date: Sep. 25, 2008

(54) AIR CONDITIONING UNIT FOR VEHICLES

(76) Inventors: Gerald Richter, Aachen (DE); Thomas Ehlers, Krefeld (DE); Mario Opiela, Aachen (DE)

Correspondence Address: FRASER CLEMENS MARTIN & MILLER LLC, 28366 KENSINGTON LANE, PERRYSBURG, OH, 43551, US

(21) Appl. No.: 12/048,247

(22) Filed: Mar. 14, 2008

(30) Foreign Application Priority Data
Mar. 19, 2007 (DE) 102007014835.8-16

(51) Int. Cl. B60H 1/00

(52) U.S. Cl. 165/42

(57) ABSTRACT

The invention relates to an air conditioning unit provided with means for cooling and heating air, including a casing with a plurality of air outlets. At least one heating heat exchanger is provided that in its vertical extension has at least one cold air passage whereby, the one cold air passage is disposed between two heating paths. An evaporator is provided, downstream of which in direction of the air flow the heating heat exchanger is disposed, such that after the heating heat exchanger there is a temperature-layered air flow, the layers of which are wholly or partly assigned directly to the air outlets.

### CROSS-REFERENCE TO RELATED APPLICATION

This application claims the benefit of German Patent Application No. DE 10 2007 014 835.8-16 filed on Mar. 19, 2007, hereby incorporated herein by reference in its entirety.

### FIELD OF THE INVENTION

The invention relates to an air conditioning unit for the conditioning of vehicles. Such air conditioning units are used in vehicles for conditioning the air in the passenger compartment, providing the passengers with a comfortable atmosphere while through conditioning the air at defined places preventing the window glasses from becoming fogged and, if necessary, enabling that the window glasses can be efficiently made free from ice. De-icing also helps enhance the safety of the vehicle passengers in bad weather conditions.

### BACKGROUND OF THE INVENTION

Generally, in vehicles there is a demand that because of the great number of technical components used in modern vehicles optimization is performed with regard of the space requirements of the individual components in order to be able to realize the desired functional variety by installing the appropriate components. Therefore, large-volume components for conditioning the air such as mixing chambers, flow guiding and vortexing devices, as they are known from stationary air conditioning units, cannot be used because of the space conditions.

Another important demand of vehicle air conditioning units is, among others, that the different air outlets of the air conditioning unit should be provided with air tempered differently depending on the position and function of the respective outlet. There is no question that the individual temperatures can be controlled within certain limits by means of damper doors and various control mechanisms but in general, there is a demand of providing the air flows to the respective outlets with preset temperature according to the respective requirement profile. Layering the air flows allows reducing the space requirements, making the saved volume available for other components in the vehicle.

Prior art knows various approaches to establish air flow layering.

One known basic principle is tapping hot air in a zone above a heat exchanger and direct said hot air through a hot air channel toward the defroster air outlets, which are situated in the upper part of the air conditioning device. Typically, the inlet of the hot air channel is below one of the air outlets into the footwell of the passenger compartment. Therefore, the temperature of the respective outlet leading into the footwell is reduced whereas the temperature of the defroster air outlet below that the hot air channel ends is increased. Temperature layering between footwell and defroster air outlets is improved by installing this type of hot air channel.

As the hot air flowing within the hot air channel is not influenced by the cold air outside the channel, a hot air channel is an efficient method of improving temperature layering. Provided that the hot air channel is given the adequate shape, pressure loss and noise level of the air conditioning device are only marginally increased, or even reduced.

If, however, the automobile manufacturer demands less temperature layering over the whole control region of the mixing door for the air conditioning device, no satisfying result can be reached with a hot air channel tapping hot air below the footwell air outlet, only directing this air toward the defroster channel. Neither the amount of hot air that reaches the defroster air outlet, nor the direction in that the air is distributed after having left the hot air channel can be controlled. The temperature of the air flowing toward the dashboard and the outlets for the driver and the passenger cannot be influenced using this type of hot air channel.

Frequently it is necessary to insert air baffles in order to further enhance temperature layering, especially for controlling the temperature of the air flowing toward the dashboard and the footwell. Depending on dimensions and arrangement of said baffles, pressure losses and noise level of the air conditioning device will be noticeably raised and in addition, space requirements of the devices are increased.

EP 1 405 743 B1 discloses a device for heating and/or air conditioning a vehicle interior with reduced pressure losses. It is proposed to connect a cold air chamber and a hot air chamber with two additional mixing chambers that feed the accompanying air outlets. Additional providing mixing chambers does have the desired result of ensuring a defined homogeneous temperature at the respective air outlets but this solution is inevitably coupled with increased installation space or additional inserts, leading to increased noise when operated.

From DE 10 337 196 A1 an air conditioning device, especially a heating or air conditioning system for vehicles is known, which has a casing provided with heat exchangers and means for dividing an air flow into two hot air partial flows heatable in the heat exchanger and into two cold air partial flows bypassing the heat exchanger. For that to be achieved two air mixing chambers are provided with a hot air partial flow and a cold air partial flow being combined in each chamber. The air mixing chambers are equipped with air inlets for the partial air flows and air outlets for mixed air to be fed to the seat areas. In order to be capable to control the temperature of the air in the footwell of the passenger cell independent of the temperature on the central level as well as in the head area, the mixed air flows exiting separately through the outlets of the two air mixing chambers are fed to the seat area in such a manner that the air flow exiting from one air mixing chamber flows into the bottom region of the seat area and the air flow exiting from the other air mixing chamber flows into the top region of the seat area.

This proposed solution has the particular disadvantage that room is needed for the split off, separately led cold air flows, which results in additional channels, hence additional installation space.

Further, DE 10 161 753 A1 discloses a heating or air conditioning system for vehicles that is provided downstream of a heater with an upper mixing chamber and a lower mixing chamber, each feedable through an upper cold air channel and a lower cold air channel, said channels situated above or below, respectively, the heater. From the lower mixing chamber, air can be directed through flow chambers positioned to the side of the heater to both the footwell of the passenger compartment and the connections of the defroster nozzles positioned on top. This heating or air conditioning system therefore allows very sensitive control of up to eight climate zones.

This solution, however, has the structural disadvantage that again the partial air flows are first separated and through own channels directed to a corresponding air chamber each and then are re-united so that the controlled amount of air at the desired temperature is accordingly available at the air outlets.

In general, the known solutions have the following disadvantages:

Due to the additional components proposed to be inserted in the air conditioning systems for achieving layering by means of channels or air guiding baffles, more acoustic problems are brought up.

Moreover, in most cases these solutions are characterized by that they include additional components in form of system parts and elements, which naturally has additional costs and mounting expenditure and accordingly additional maintenance efforts as well, as a consequence.

Also, from the view of fluid mechanics, the additional inserts in the system lead to increased pressure drop resulting in increased power demand and eventually, increased energy consumption, hence reduced efficiency of the whole motor vehicle.

### SUMMARY OF THE INVENTION

Now, the object of the invention is to provide an air conditioning unit that almost without additional inserts, oriented on demand and functions, provides air flows with the desired temperature at the individual air outlets, while keeping the space requirements of the air conditioning unit very low.

The problem is solved according to the invention by that the vehicle air conditioning unit is provided with means for cooling and heating air and has a casing with at least three air outlets, whereby as a means for heating the air at least one heating heat exchanger is provided that in its vertical extension has at least one cold air passage, whereby one cold air passage is disposed between two heating paths. As a means for cooling the air, an evaporator is provided that in direction of the air flow is disposed upstream of the heating heat exchanger in such a way that after the heating heat exchanger there is a temperature-layered air flow, the layers of which are wholly or partly assigned directly to the air outlets.

The concept of the invention is that already due to the arrangement and establishment of the components that control the temperature of the air, i.e. heat exchanger and evaporator, the air conditioning unit is established such that a natural layering according to the requirement profile of the air outlets is already given by design, without additional mixing zones and additional channels being needed.

The requirement profile of the air outlets defines the temperature of the air flow in the order of a hot air flow to the defroster outlet, a colder air flow to the passenger outlet and the driver outlet, respectively, and a warmer air flow again to the footwell outlet. Eventually, the solution according to the invention realizes the principle that each air outlet more or less has its own heat exchanger that is already is effective due to the arrangement and forced passage of the components in the defined direction from the air inlet at the evaporator to the air outlets after the heating heat exchanger, although in the end the individual heat exchanger zones are combined with each other by function, and thus are established efficiently saving components.

The concept of the invention is realized by that a heating heat exchanger is used that is equipped with a cold air passage. Hence the cold air is not led past the heat exchanger as in solutions of prior art, but it is led passing through the heat exchanger. Therefore the heat exchanger has been separated, according to the invention, to form several, at least two heating zones between which a cold air passage is provided.

The heating heat exchanger is designed such that the cold air passage divides the heat exchanging area of the heating heat exchanger in a ratio of 1/3 to 2/3. Alternatively, the cold air passage can also be disposed centrally in the heating heat exchanger, thus dividing the heat exchanging capacity into two parts. Depending on the requirement profile of the air outlets assigned to the air layers, also a ratio of division of the heat exchanging area by the cold air flow(s) adapted to the corresponding requirement profile is possible.

Usually, the air conditioning device has three outlet planes, one for the footwell region, preferably arranged in the lower area of the device, one for the defroster region in the upper area of the device, and one for the ventilation of the passengers over the dashboard region, arranged mainly centrally seen in side view.

The division of the heat exchanging area of the heating heat exchanger is chosen such that both hot regions, the defroster region and the footwell region, are assigned each to a heating zone of the heat exchanger so that two heating paths for the hot air flows are defined, which are separated from the cold air layer disposed in the central region between said hot air flows.

Because of that a layering is established in the air conditioning device that corresponds to the layering of the outlets. Upstream of the heating heat exchanger there is a temperature control door system that controls the air mass flows through both elements of the heat exchanger and through the cold air passage, respectively, in the usual manner. The arrangement of the temperature control system is chosen such that inflow into the cold path and the hot paths as free as possible from losses and noise is achieved. Temperature control is advantageously realized by temperature control doors and/or temperature control slides. Assumed to be particularly preferred is a combination of a temperature control door and a temperature control slide. In a preferred embodiment, a temperature control slide accommodation chamber is provided to accommodate the temperature control slides in a “full-hot position”

An alternative embodiment is that the heating heat exchanger is provided with several cold air paths. The cold air paths in the heating heat exchanger are preferably established to be thermally insulated from the heating heat exchanger using a frame or the like, in order to keep heat transmission to the cold air flow through the heating heat exchanger as low as possible, or to completely prevent it, respectively.

Air distribution doors are added immediately at the air outlets in a usual way so that the air flows at the air outlets can be controlled.

As usual, the heating heat exchanger itself is constructed of side tanks, which are connected through flat pipes. Between the flat tubes fins are established enlarging the heat exchanger surface. The air flow passes the fin structure picking up heat from the heating heat exchanger. In the region of the cold air passages preferably, there are no flat pipes so that a cost-effective embodiment of such a heat exchanger is, in particular, that in a central area, the heat exchanger is not provided with either flat pipes or fins.

In principle, the heating paths for heating the air flows could also be established using separate heating heat exchangers connected with each other. This embodiment is included in the invention as specified by the concept, but is a more complex and hence more costly solution to be mentioned, however, for the sake of completeness.

Another advantageous embodiment of the invention is that the heating heat exchanger is provided with additional heaters.

According to an embodiment of the invention, PTC-heating heat exchangers are used as additional heaters, or the heating heat exchanger itself is established as a PTC-heating heat exchanger. It is particularly comfortable, according to an advantageous embodiment of the invention, that the heating path that corresponds with the bottom outlet, in addition to the heating heat exchanger, is equipped with an additional heater. Often the passengers of the vehicle welcome a slightly increased temperature realized in the footwell zone.

Another advantageous embodiment of the invention is that in a portion of the cold air passage, a cold air channel entrance is disposed that enables cold air to be tapped of the cold air passage. This cold air channel can directly be run to an outlet of the air conditioning device so that it is possible to provide one or several outlets with an air flow at a defined lower temperature.

The solution according to the invention has various advantages.

Because inserts in the air conditioning device are dispensed with, the flow path can be designed more efficient so that the pressure losses of the system are minimized. This results in lower energy consumption.

Running the cold air path through the heating heat exchanger results in an improved cold air flow compared to the solutions of prior art, because the air can be passed at lower losses and noise.

Refraining from additional inserts also means reduced components, hence lower material and manufacture costs as well as reduced expenditure for maintenance and repair.

It is a decisive advantage that the overall size of such an air conditioning device can be reduced compared to other solutions, which is particularly important in the field of vehicle building.

Further, the natural layering of the individual air flows ensures in an especially advantageous manner that the requirements of automatic control can be met even by the pre-set layering without posing bigger problems.

### BRIEF DESCRIPTION OF THE DRAWINGS

Further details, features, and advantages of the present invention will become apparent from consideration of the following description when taken in connection with the accompanying drawings in which is shown:

FIG. 1 is an air conditioning device in central sectional view, with a heating heat exchanger having a cold air passage;

FIG. 2 is a heating heat exchanger having a cold air passage;

FIG. 3 is an air conditioning device in central sectional view, with a heating heat exchanger having two cold air passages; and

FIG. 4 is a PTC-heating heat exchanger having two cold air passages.

### DETAILED DESCRIPTION OF THE PREFERRED EMBODIMENT

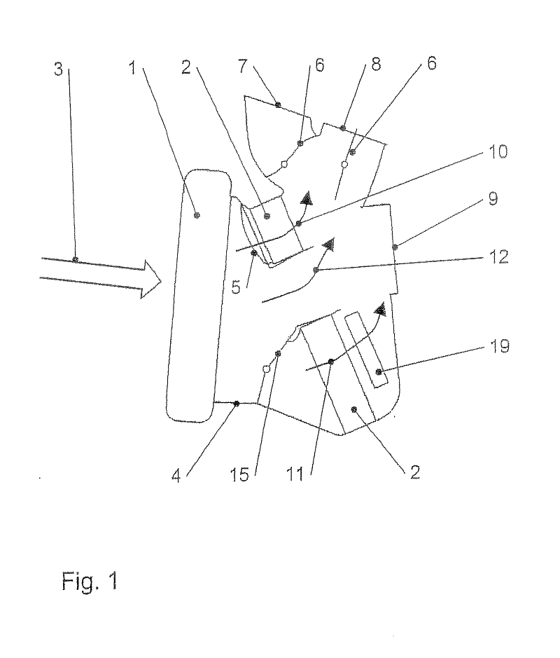

In FIG. 1 an air conditioning device is shown in central sectional view.

According to the concept of the invention, both heating paths and the cold air passage as well are arranged such that they meet the requirements of layering and correspond to the outlet positions. The arrangement of the temperature control system is chosen such that inflow into the cold air path is as free of losses and noise as possible. In a preferred embodiment of the invention three single doors are used that separately control the three air layers of the total flow. In the alternative version shown in FIG. 1 a temperature control slide 5 in conjunction with a temperature control door 15 are used as temperature control elements that are connected to each other via a kinematic mechanism.

The air conditioning device essentially includes an evaporator 1 and a heating heat exchanger 2, both arranged in a casing 4. The casing 4 is provided with three air outlets 7, 8, 9. The direction of the air flow is indicated by the arrow marked with the numeral 3. In direction of air flow 3 upstream of the heating heat exchanger 2, there is the temperature control slide 5 and in the lower part, the temperature control door 15. In its central area, the heating heat exchanger 2 is provided with a cold air passage 12. Due to the division of the heating heat exchanger 2 by the cold air passage 12, a heating path 10 is formed in the upper zone of the heating heat exchanger 2 and a heating path 11 is formed in the lower zone of the heating heat exchanger 2. The heating paths 10, 11 heat the air that passes through the respective zones of the heat exchanger. The cold air passage 12 enables cold air to pass, which has entered the air conditioning device over the evaporator 1. The cold air flows via the cold air passage 12 through the heating heat exchanger 2 without picking up a noticeable amount of heat. The air outlets are equipped with air distribution doors 6. According to the concept of the invention, a layered flow develops due to the segmentation of the heating heat exchanger 2. The advantageous effect now is that the temperature of the air layers meets the requirement profile of the assigned air outlets 7, 8, 9.

The air outlet 7 is the defroster outlet where hot air should exit preferably for de-icing the window glasses and keeping them transparent. This hot air develops from a partial air flow of the air that has entered the air conditioning device over the evaporator 1, where the air first is cooled and dried while the partial air flow is then heated via the heating path 10 of the heating heat exchanger 2. Hence, this partial air flow is hot and dry.

At the air outlet 8, the passenger- or driver outlet, the exiting air must not be too hot as persons often find it uncomfortable when they are hit by too hot air in the chest and face areas. Therefore it is desired that the air layer exiting through the air outlet 8 is not heated to the same extent as the air exiting through the defroster outlet 7. To this end, in the heating heat exchanger 2 there is the cold air passage 12. The air cooled in the evaporator 1 first flows through the heating heat exchanger 2 without being heated markedly, then mixing only little with both adjacent hotter air flows. Depending on the requirement profile, heating of this air flow can of course be varied via a corresponding position of the temperature control elements 5 and 15.

Finally, at the air outlet 9, i.e. the bottom outlet for the footwell zone of the vehicle, again hotter air is desired, as passengers welcome this as a rule. The hot air required for this air outlet is available after the air having entered the air conditioning device over the evaporator 1 has been heated over the heating path 11. The air heated in the heating path 11 as the lowest layer of the air flow eventually flows to the bottom outlet 9, there exiting from the air conditioning device. In the example of embodiment, an additional heater 19 is installed for additional heating the air for the footwell zone, which exits from the bottom outlet 9.

In the example of embodiment, the cold air passage 12 segments the heating heat exchanger into a heat exchanging region for the heating path 10 and a heat exchanging region for the heating path 11. The accompanying heat exchanging surface is about ⅓ of the capacity of the heating heat exchanger 2 for the heating path 10, ⅔ of the capacity of the heating heat exchanger 2 for the heating path 11.

The temperature control slide and temperature control door 5 and 15 are coupled such that the temperature can be set by means of one actuator. Alternatively, in order to establish a certain layering, the individual doors can be actuated using separate actuating motors, which if necessary can be operated synchronously. The cold air passage 12 is arranged in the heating heat exchanger 2 such that both a layering of the air flow is achieved and, if required, the cold air flow can reach the air outlet 8 almost uninfluenced.

The cold air passage 12 is separated by a frame not shown from the heating heat exchanger 2, the frame insulating the cold air from the hot inner walls of the heating heat exchanger 2 and also serving as a stop for the temperature control doors 15 or temperature control slides 5.

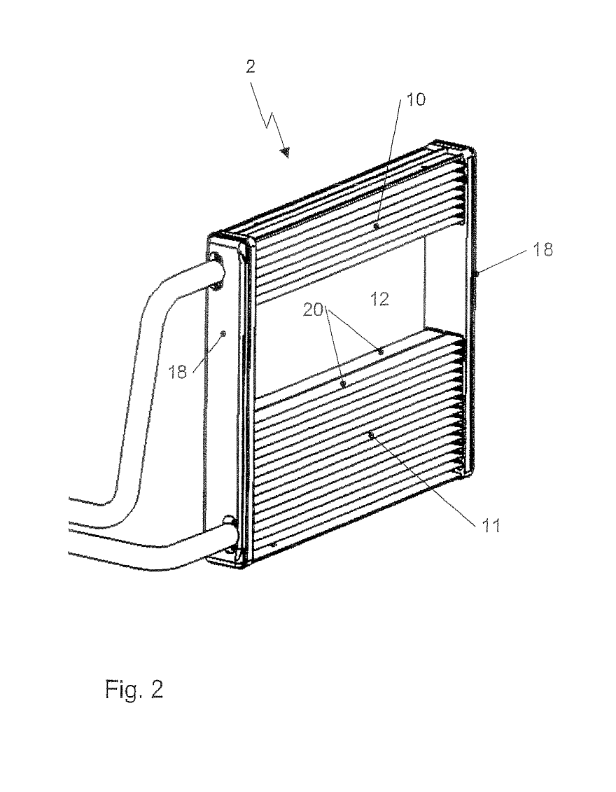

In FIG. 2 a segmented heating heat exchanger 2 is shown. The heating heat exchanger 2 essentially includes two side tanks 18 that are connected to each other by flat pipes 20. Fins (not shown) are disposed between the individual flat pipes, the fins enlarging the heat exchanging surface that transmits heat from the heating medium flowing through the flat pipes to the air.

The heating heat exchanger 2, in the form shown, is provided with a heating path 10 and a heating path 11, with a cold air passage 12 in between. The cold air passage 12 is established by that in this area no flat pipes 20 are disposed.

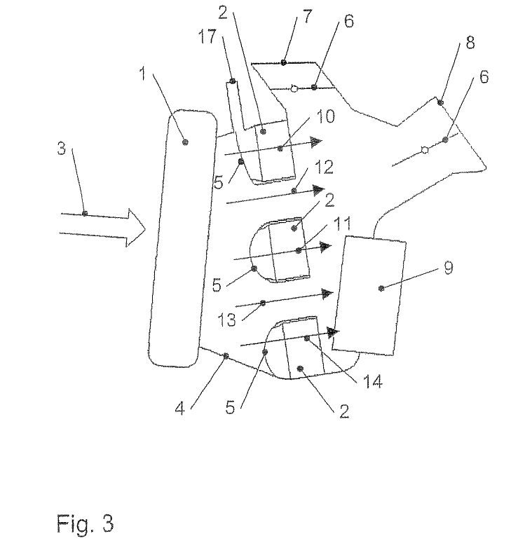

FIG. 3 an air conditioning unit is shown in central sectional view, which allows achieving an a bit more expensive but also more precise control of the temperatures of the air layers, compared with the embodiment previously described. In this embodiment, apart from the elements that have already been shown and described in FIG. 1, a heating heat exchanger 2 is disposed that has two cold air passages 12 and 13. Thus, for the heating heat exchanger 2 three heating paths 10, 11, 14 and two cold air passages 12 and 13 follow. Upstream of the heating heat exchanger 2 a temperature control slide 5 is arranged as temperature control element, provided with cut-outs corresponding with the cold air passages 12 and 13. For accommodation of the temperature control slide 5, a temperature control slide accommodation chamber 17 is provided in the area of the casing 4 above the heating heat exchanger 2.

The temperature control slide 5 makes possible to completely close the heating paths 10, 11 and 14, and at the same time, to release the cold air passages 12 and 13. On the other hand, in the case of maximum heating of the air, the temperature control slide 5 is totally moved in the temperature control slide accommodation chamber 17 of the casing 4 so that the heating paths 10, 11 and 14 are completely opened, whereas the cold air passages 12 and 13 are closed.

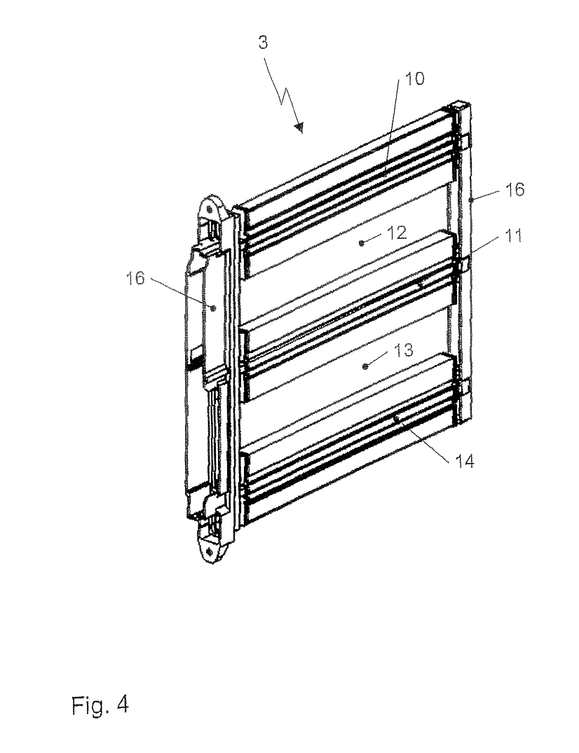

In FIG. 4 a PTC-heating heat exchanger 2 is shown that, similar to the liquid-based heating heat exchangers, is provided with geometrically equally shaped openings for the cold air passages 12 and 13, as well as the heating paths 10, 11 and 14. The PTC-heating element can also be established as additional heater geometrically corresponding with the heating heat exchanger 2, in the direction of air flow 3 arranged downstream of the heating heat exchanger 2. The PTC-heating element essentially includes two headers 16, between which heat exchanging elements are disposed.

### NOMENCLATURE

1 evaporator
2 heating heat exchanger
3 direction of air flow
4 casing
5 temperature control slide
6 air distribution doors
7 air outlet, defroster outlet
8 air outlet, passenger-, driver outlet
9 air outlet, bottom outlet
10 heating path
11 heating path
12 cold air passage
13 cold air passage
14 heating path
15 temperature control door
16 header
17 temperature control slide accommodation chamber (pocket)
18 side tank
19 additional heater
20 flat pipes

What is claimed is:

1. An air-handling system of a heating, ventilating, and air-conditioning system for a vehicle comprising:
a casing having an inlet, and a plurality of outlets in fluid communication with a passenger compartment of the vehicle;
a heat exchanger disposed in said casing having at least one cold air passage formed therein between two heating paths; and
an evaporator disposed upstream of said heat exchanger for cooling a supply of air, wherein the cold air passage and the heating paths of said heat exchanger cooperate to create a temperature layered air flow for supply to the outlets.

2. The system according to claim 1, wherein the cold air passage divides the two heating paths into a ratio of about one third to two thirds of the surface area of a heating portion of said heat exchanger.

3. The system according to claim 1, wherein the cold air passage is disposed centrally in said heat exchanger.

4. The system according to claim 1, wherein the heat exchanger includes two cold air passages, each cold air passage disposed between two heating paths.

5. The system according to claim 1, wherein the cold air passage is substantially thermally insulated from the heating paths.

6. The system according to claim 1, further comprising a plurality of air distribution doors disposed in said casing to selectively block the outlets of said casing.

7. The system according to claim 1, further comprising at least one of a temperature control door and a temperature control slide disposed in said casing to selectively block the cold air passage.

8. The system according to claim 7, further comprising a chamber formed in said casing to house the temperature control slide.

9. The system according to claim 1, wherein said heat exchanger includes two side tanks in fluid communication with each other by a flat conduit having a plurality of fins arranged thereon.

10. The system according to claim 1, wherein the heating paths are formed by separate heat exchangers.

11. The system according to claim 1, wherein the heat exchanger includes an additional heater.

12. The system according to claim 11, wherein at least one of said heat exchangers and the additional heater is an electrically operated positive temperature coefficient heat source.

13. The system according to claim 1, wherein one of the outlets at a lowermost point in the casing includes a heater.

14. An air-handling system of a heating, ventilating, and air-conditioning system for a vehicle comprising:
a casing having an inlet, and a plurality of outlets in fluid communication with a passenger compartment of the vehicle;
a plurality of air distribution doors disposed in said casing to selectively block the outlets of said casing;
a heat exchanger disposed in said casing having at least one cold air passage formed therein between two heating paths; and
an evaporator disposed upstream of said heat exchanger for cooling a supply of air, wherein the cold air passage and the heating paths of said heat exchanger cooperate to create a temperature layered air flow for supply to the outlets.

15. The system according to claim 14, wherein the cold air passage divides the two heating paths into a ratio of about one third to two thirds of the surface area of a heating portion of said heat exchanger.

16. The system according to claim 14, further comprising at least one of a temperature control door and a temperature control slide disposed in said casing to selectively block the cold air passage.

17. The system according to claim 14, wherein the heating paths are formed by separate heat exchangers.

18. The system according to claim 14, wherein at least one of said heat exchangers and the additional heater is an electrically operated positive temperature coefficient heat source.

19. The system according to claim 14, wherein one of the outlets at a lowermost point in the casing includes an additional heater.

20. An air-handling system of a heating, ventilating, and air-conditioning system for a vehicle comprising:
a casing having an inlet and a plurality of outlets in fluid communication with a passenger compartment of the vehicle;
a plurality of air distribution doors disposed in said casing to selectively block the outlets of said casing;
at least one of a temperature control door and a temperature control slide disposed in said casing to selectively block the cold air passage;
a heat exchanger disposed in said casing having at least one cold air passage formed therein between two heating paths; and
an evaporator disposed upstream of said heat exchanger for cooling a supply of air, wherein the cold air passage and the heating paths of said heat exchanger cooperate to create a temperature layered air flow for supply to the outlets.
